(19) United States
(12) Patent Application Publication
(10) Pub. No.: US 2025/0328486 A1
(43) Pub. Date: Oct. 23, 2025

(54) INTERFACE SYSTEM ON A CHIP FOR AUTOMOTIVE APPLICATIONS

(71) Applicant: ZF Friedrichshafen AG, Friedrichshafen (DE)

(72) Inventors: Jonas Gomes Filho, Meckenbeuren (DE); Frank Gruson, Lindau (DE); Oliver Briemle, Friedrichshafen (DE)

(73) Assignee: ZF Friedrichshafen AG, Friedrichshafen (DE)

(21) Appl. No.: 19/183,070

(22) Filed: Apr. 18, 2025

(30) Foreign Application Priority Data
Apr. 18, 2024 (DE) 10 2024 203 602.1

(51) Int. Cl. G06F 13/42

(52) U.S. Cl. CPC G06F 13/4221; G06F 2213/0026

(57) ABSTRACT

An interface system on a chip includes numerous input interfaces configured for at least two different communication protocols and configured to receive sensor data from numerous sensors, a preprocessing unit for processing sensor data, and at least one output interface configured for a specific communication protocol for outputting the sensor data.

### CROSS-REFERENCE TO RELATED APPLICATION

This application claims priority to German Patent Application No. 10 2024 203 602.1 filed on Apr. 18, 2024, the entirety of which is hereby fully incorporated by reference herein.

### TECHNICAL FIELD

The present disclosure relates to an interface system on a chip, and a vehicle system that contains such an interface system.

### BACKGROUND

The number of sensors incorporated in vehicles has significantly increased due to partially autonomous and fully autonomous vehicles. Camera systems, lidar systems, and radar systems, which require a lot of bandwidth, represent new challenges in terms of data distribution, processing and safety. There are presently a variety of systems on a chip (SoCs), with which this data can be distributed (PCIe and ethernet switches), processed (performance SoCs), synchronized, etc.

### SUMMARY

An object of the present disclosure is to convert the sensor data in a vehicle from the final processing, for the distribution, processing and synchronization thereof in order to control the vehicle.

This problem is solved by the subject matter disclosed herein. Other embodiments can also be derived from the following description.

One aspect of the present disclosure relates to an interface system on a chip. A system on a chip (SoC) is an integrated circuit (IC) on a single chip. The interface system comprises numerous interfaces with different protocols for reading sensor data from different sensors, and to output them with a specific interface or protocol. The data are preprocessed and/or synchronized in the interface system. The interface system is configured to preprocess and potentially synchronize sensor data from numerous sensors such that they conform to safety protocols. The interface system on a chip enables preprocessing of data, aggregation and synchronization of data, and distribution of this data through a standard interface such as PCIe (Peripheral Component Interconnect Express) or UCIe (Universal Chiplet Interconnect Express).

In various embodiments, the interface system comprises numerous input interfaces, which are configured for at least two different communication protocols, and can receive sensor data from numerous sensors. The sensors can be a camera, radar, and/or lidar system, and/or can be configured to monitor the vehicle's environment. There can be an input interface for each sensor. The communication protocols can provide data and/or data packets serially. The communication protocols can be for the Mobile Industry Processor Interface (MIPI), Camera Serial Interface (CSI), Gigabit Multimedia Serial Link (GMSL), Flat Panel Display Link (FPD-link) and/or ethernet.

An input interface for the interface system can be a physical interface that implements the protocol components of the physical layer connected to the respective sensor. It is also possible to incorporate a deserializer between the sensor and the input interface that generates data packets from a serial data stream.

In various embodiments, the interface system contains a preprocessing unit for processing sensor data, e.g. using image signal processing (ISP), digital signal processing for radar and lidar, and/or an AI accelerator for general operations, e.g. object recognition. The data from numerous sensors can be processed with higher bandwidths in realtime by efficient hardware, while ideally reducing power consumption.

The interface system in various embodiments contains at least one output interface configured to output data with a specific communication protocol. The specific communication protocol can be PCIe or UCIe. The interface system can contain numerous output interfaces with the specific communication protocol, each of which can be connected to an application system on a chip, another interface system, and/or other systems such as a diagnostic interface for other computer systems in the vehicle (such as ECUs), drives, cloud systems, data logging systems, etc.

An application system can be a system on a chip that is configured to execute application software for the vehicle system. The interface system allows for the implementation of specific application software, using embedded software. The processing by the interface system can improve the software architecture of the vehicle system, and relieve the application systems, such that they perform better when dealing with more complex tasks such as AI processing.

The interface system in various embodiments also contains a synchronizing unit for the sensor data in which sensor data acquired at the same time are given the same timestamp. All input data can be synchronized by the synchronizing unit, which can contain its own internal clock. The sensor data are issued a timestamp during the synchronization. The interface system can be configured to function in streaming mode, resulting in a deterministic system. Timestamps and sensor synchronization are much easier to implement when all of the data is combined in a single component, i.e. the interface system.

Data is sequentially processed in the streaming mode, without the processor having to wait for the end of the command cycle. This results in an efficient processing of data streams, e.g. multimedia applications (streaming video or audio). Streaming architectures often use parallel pipelines in order to be able to process numerous data streams simultaneously. Each pipeline executes specific operations, e.g. arithmetic, filtration, or transformation. On the whole, an efficient processing of data streams is obtained in the streaming mode, which is synchronized to continuous data streams.

The interface system in various embodiments also contains an automotive interface for communicating with control units in the vehicle. The automotive interface can use typical communication protocols for vehicles, e.g. CAN, CAN-FD, I2C, SPI, FlexRay, etc.

In various embodiments, at least one of the input interfaces is configured for the CSI protocol. The CSI protocol enables communication with a camera.

In various embodiments, at least one of the input interfaces is configured for the ethernet protocol. The ethernet protocol enables communication with a radar or lidar sensor.

The interface system in various embodiments contains numerous output interfaces for the specific communication protocol. All output interfaces are configured for the same communication protocol, e.g. PCIe or UCIe. The interface system translates the data in the form of the communication protocols for the input interfaces into data that can be output by the output interfaces in the specific communication protocol.

The preprocessing unit in various embodiments contains an image signal processor for image data. The image data can then be converted from a format specific to the camera into a format that can be processed by the application system.

The preprocessing unit in various embodiments can contain a digital signal processor for processing radar data and/or lidar data. In general, data from a sensor in a specific format can be converted to a format that can be processed by the application system.

The interface system in various embodiments can also contain a safety unit, which has at least two, potentially three processors that work in parallel, the results of which are compared with one another by the safety unit. Safety functions can be carried out with the safety unit, which can still provide reliable results if one of the processors crashes or otherwise fails.

The interface system in various embodiments also contains a processor unit with numerous processors. Other functions of the interface system can be carried out by the processor unit, such as classical functions in the embedded software, e.g. controlling cameras an sensors, temperature and energy monitoring, and ventilation regulation.

The interface system in various embodiments also contains a data communication network for distributing data among various units in the interface system. The data communication network can be a network on a chip (NoC) or bus system.

The interface system in various embodiments also contains an internal memory used by the preprocessing unit and the processors.

The interface system in various embodiments also contains a memory interface for accessing an external drive that is used to expand the internal drive.

Another aspect of the present disclosure relates to a vehicle system that has an interface system like that described herein. The vehicle system can be the main computer or ECU for a vehicle with which autonomous or partially autonomous control of the vehicle is obtained.

The vehicle system in various embodiments contains numerous sensors for monitoring a vehicle's environment, including at least one application system on a chip, which is configured to control the vehicle, and one interface system on a chip, the input interfaces of which are connected to numerous sensors, while its at least one output interface is connected to the at least one application system.

According to various embodiments, the vehicle system also contains at least two interface systems on a chip that are connected to one another by an output interface, in which the interface systems are connected to different sets of sensors. By using numerous interface systems, each of which is on a respective chip, all of which can have the same structure, the vehicle system can be redundant and functionally conform to safety protocols.

Exemplary embodiments of the present disclosure shall be explained in greater detail below in reference to the drawings.

### BRIEF DESCRIPTION OF THE DRAWINGS

FIG. 1 schematically shows a vehicle system according to various embodiments of the present disclosure;

FIG. 2 schematically shows a vehicle system according to another embodiment of the present disclosure; and

FIG. 3 schematically shows an interface system according to another embodiment of the present disclosure.

### DETAILED DESCRIPTION

The reference symbols in the drawings are listed at the end of this description. Identical or similar components generally have the same reference symbols.

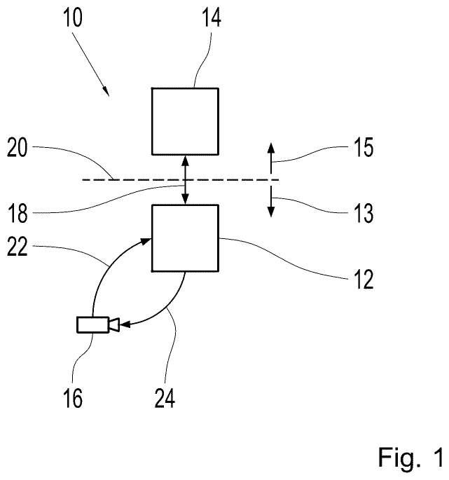

FIG. 1 shows a schematic illustration of a vehicle system 10 composed of an interface system 12 on a chip and an application system 14 on a chip. The vehicle system 10 is part of the control system for an autonomous or semi-autonomous vehicle. Software 13 embedded in the interface system 12 is carried out, i.e. software for specific hardware in the vehicle system 10, e.g. a camera 16. Application software 15 can be carried out in the application system 14, i.e. software implemented without the hardware in the vehicle system 10.

The two systems 12, 14 are connected to a data communication connection 18 using PCIe or UCIe. The data communication connection 18 forms conversion layer 20 between the application software 15 level and the embedded software 13 level.

The interface system 12 acquires data 22, e.g. sensor data from the hardware in the vehicle system 10, and converts it to standardized data that is then sent to the application system 14. The interface system 12 can also convert commands from the application system 14 into hardware commands 24 for the hardware components, e.g. a camera 16. The interface system 12 therefore takes care of the hardware-specific requirements of the sensors and/or actuators in the vehicle system 10. The application software 15 in the application system 14 can be implemented independently of specific hardware components. The application system 14 can also be replaced without having to modify the embedded software 13 in the interface system 12.

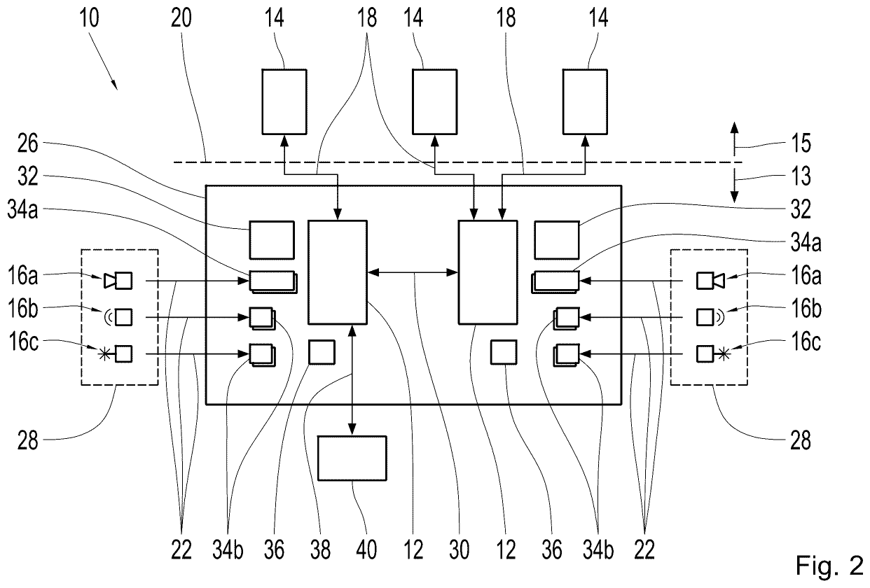

FIG. 2 shows another vehicle system 10 that contains numerous interface systems 12 and application systems 14, each of which is on a chip. The vehicle system 10 can be a high-performance computer for an electronic control unit (ECU) in an autonomous or semi-autonomous vehicle.

An interface unit 26 in the vehicle system 10 contains two interface systems 12 (each of which is on a separate chip), which are connected to two sets 28 of sensors by different interfaces. Each set 28 of sensors can contain a camera 16a, radar 16b, and/or lidar 16c. There can also be numerous cameras 16a, radars 16b, and/or lidars 16c.

The interface systems 12 are connected to one another by a data communication connection 30 using the PCIe or UCIe protocols. The interface systems 12 are connected to the application systems 14 by other data communication connections 18 using the PCIe or UCIe protocols. Consequently, a first interface system 12 can be connected to a first application system 14 and a second interface system 12 can be connected to one or more other application systems 14.

The application systems 14 can have different functions. The two sets 28 of sensors and the two interface systems 12 divide the interface unit 26 into two redundant area, such that if one of the sensor sets 28 and/or interface systems 12 fails, the interface unit 26 can still function. The data communication connection 30 can be used to send sensor data from the sensor set 28 and/or control data from the application system 14 between the interface systems 12, to obtain greater redundancy.

The conversion layer 20 isolates the application software 15 from the interface unit 26 and/or the hardware components, e.g. the sensor sets 28 and the sensors, ventilators, coolers, AD and DA converters, controls, etc. The application software 15 can be used solely for object recognition, pixel segmentation, L4 functions, etc.

FIG. 2 also shows that the interface unit 26 contains components other than the interface systems 12, each of which is on a separate chip.

The application system 12 can make use of a microcontroller (MCU) 32. The MCU monitors and controls safety functions by detecting errors. By way of example, it constantly monitors the state of the control unit, and detects errors or deviations from the expected functionality. If an error occurs, the MCU implements safety mechanisms in reaction thereto, e.g. through redundancy, monitoring of the sensors and actuators, and in reaction to status changes.

Each sensor 16a, 16b, 16c has a physical interface 34a, 34b that receives the

sensors data on a physical level and sends it to the interface system 12. There can be a deserializer 34a for processing the sensor data from a camera 16a, which generates data packets for the interface system 12 from the serial data from the camera 16a. There can also be a physical ethernet interface 34b for each sensor 16b, 16c that communicates through the ethernet.

An external RAM 36 can expand the internal RAM in the interface system 12.

Another data communication connection using PCIe or UCIe can be used to obtain a diagnostics interface (MDI), and/or an interface for another high-performance computer, or ECU 40 in the vehicle system 10.

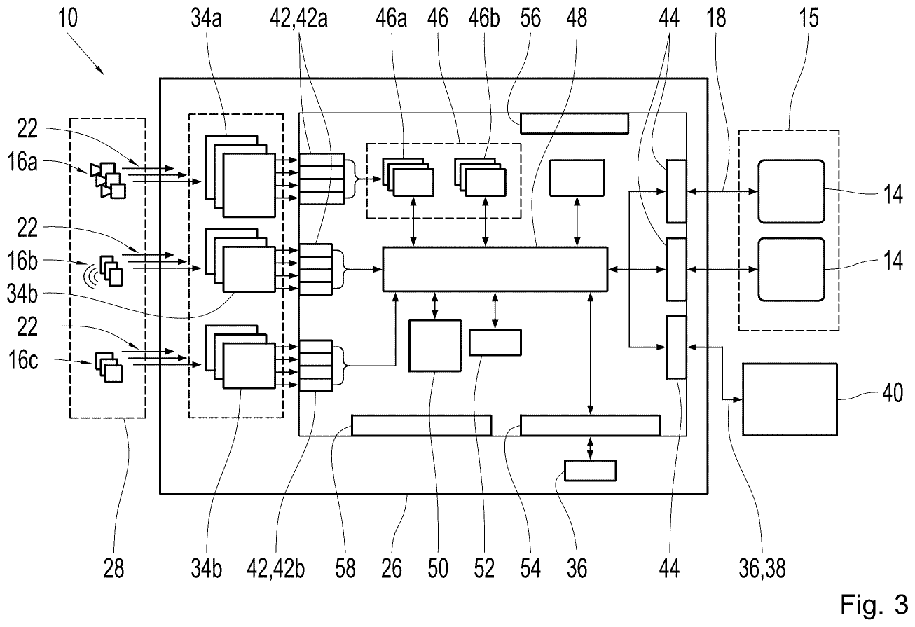

FIG. 3 shows a more detailed illustration of an embodiment of an interface system 12. The interface system 12 contains numerous input interfaces 42 configured for at least two different communication protocols, and configured to receive sensor data 22 from numerous sensors 16a, 16b, 16c. The interface system 12 also contains at least one output interface 44 configured for a specific communication protocol for output sensor data that has been preprocessed and potentially synchronized by the interface system 12.

One of the input interfaces 42a can be configured for the CSI protocol. This allows communication with a camera 16a functioning as a sensor. One of the input interfaces 42b can be configured for the ethernet protocol. This allows communication with a radar 16b or lidar 16c functioning as a sensor. The respective input interfaces 42 can comprise a physical interface 34a, 34b, which implement protocol components of the physical layer, that are connected to the respective sensors 16a, 16b, 16c. A deserializer 34a that generates serial data from the sensor data packet, can be interconnected between the sensor 16a and the input interface.

Some of the sensor data 22, in particular image data, can be preprocessed by a preprocessing unit 46. This preprocessing unit 46 can contain one or more image signal processors 46a for processing image data and/or one or more digital signal processors 46b for processing data in general.

The interface system 12 contains a data communication network 48, such as a bus system, for sending data between input interfaces 42, output interfaces 44, the preprocessing unit 46, and other components in the interface system 12. The optionally preprocessed sensor data 22 from the sensors 16a, 16b, 16c are sent through the data communication network 48 to the output interface 44, which then sends the sensor data 22 using a specific communication protocol, e.g. PCIe or UCIe, to other components in the vehicle system 10.

The sensor data 22 from the camera 16a stream through a digital signal processor 46b and then through the data communication network 48 to the output interfaces 44. The sensor data 22 from the radar 16 and lidar 16c stream directly into the data communication network 48, which then sends them to a digital signal processor 46b and/or a processor unit 50. The processor unit 50 can contain numerous processors that preprocess the sensor data 22 with software.

Intermediate results and software can be stored in an internal drive 52 or an external drive 36. The internal drive 52 is directly connected to the data communication network 48. A memory interface 54 connected to the data communication network 48 is able to access the external drive 36. The internal drive 52 is used primarily, to avoid the slower access to the external drive 36.

The interface system 12 also contains a synchronization unit 56 for the sensor data 22, in which sensor data 22 acquired at the same time is given the same timestamp. This also takes place if the frequency of the sensor data, or the sensors 16a, 16b, 16c differs.

The interface system 12 can also contain an automotive interface 58 for sending data to control units in the vehicle, e.g. a CAN bus.

The interface system 12 can also contain a safety unit 60 that can execute functions safely. The safety unit 60 can contain at least two processors that function in parallel, the results of which are then compared with one another by the safety unit 60.

The preprocessed and synchronized sensor data 22 are sent by the data communication network 40 to the output interfaces 44.

The output interfaces 44 can send the sensor data 22 to numerous components in the vehicle system 10 at the application level. Performance systems 14, e.g. CPUs, GPUs, can execute complex computing tasks, e.g. AI classifications, autonomous driving functions, etc. Furthermore, data logging and recording devices, e.g. external SSDs, HDs and/or cloud connections, can be connected to the output interfaces 44.

Other high-performance computers and/or ECUs 40 can be connected to the output interfaces 44.

It should also be noted that the term “comprises” does not exclude other elements, and articles “one” and “a” do not exclude pluralities. It should also be noted that features or steps described in reference to one of the above exemplary embodiments can also be used in combination with other features or steps in other exemplary embodiments described above. Reference symbols in the claims are not to be regarded as limiting.

### REFERENCE SYMBOLS

10 vehicle system
12 interface system on a chip
13 embedded software
14 application system on a chip
15 application software
16 vehicle sensor, camera
16a camera
16b radar
16c lidar
18 data communication network
20 conversion layer
22 data, sensor data
24 data, control commands
26 interface unit
28 sensor set
30 data communication connection
32 microcontroller
34a physical interface, deserializer
34b physical interface, physical ethernet interface
36 external RAM
38 data communication connection
40 high-performance computer, ECU
42, 42a input interface
42, 42b input interface
44 output interface
46 preprocessing unit
46a DSP
46b ISP
48 data communication network
50 processor unit
52 internal drive
54 memory interface
56 synchronization unit
58 automotive interface
60 safety unit

1. An interface system on a chip, comprising:
a plurality of input interfaces configured for at least two different communication protocols, and configured to receive sensor data from a plurality of sensors;
a preprocessing unit configured to process the sensor data; and
at least one output interface configured for a specific communication protocol for outputting the sensor data.

2. The interface system according to claim 1, comprising:
a synchronization unit configured to synchronize the sensor data, wherein sensor data recorded at a same time are given a same timestamp.

3. The interface system according to claim 1, comprising:
an automotive interface configured to communicate with control units in a vehicle.

4. The interface system according to claim 1,
wherein an input interface of the plurality of input interfaces is configured for a Camera Serial Interface (CSI) protocol.

5. The interface system according to claim 1,
an input interface of the plurality of input interfaces is configured for an ethernet protocol.

6. The interface system according to claim 1, comprising:
a plurality of output interfaces for one or more specific communication protocols.

7. The interface system according to claim 1,
wherein the specific communication protocol for the output interface is PCI express or UCI express.

8. The interface system according to claim 1,
wherein the preprocessing unit comprises an image signal processor configured to process image data.

9. The interface system according to claim 1,
wherein the preprocessing unit comprises a digital signal processor configured to process radar data and/or lidar data.

10. The interface system according to claim 1, comprising:
at least one of the following:
a safety unit having at least two processors that work in parallel, results of which are compared with one another by the safety unit;
a processor unit comprising a plurality of processors;
a data communication network configured to send data between units in the interface system;
an internal drive; and/or
a drive interface configured to access an external drive.

11. A vehicle system comprising:
a plurality of sensors configured to monitor a vehicle's environment; and
at least one application system on a chip configured to control a vehicle; and
the interface system on a chip according to claim 1, wherein the input interfaces are connected to the plurality of sensors, and wherein the at least one output interface is connected to the application system.

12. The vehicle system according to claim 11, comprising:
a second interface system on a chip, wherein the interface system on a chip and the second interface system on a chip are connected to one another by an output interface, wherein the interface systems are connected to different sensor sets.
